(19) United States
(12) Patent Application Publication
(10) Pub. No.: US 2022/0292553 A1
(43) Pub. Date: Sep. 15, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventors: Sho KOHATA, Kanagawa (JP); Ryota SUZUKI, Kanagawa (JP); Masanori YOSHIZUKA, Kanagawa (JP)

(73) Assignee: FUJIFILM Business Innovation Corp., Tokyo (JP)

(21) Appl. No.: 17/385,948

(22) Filed: Jul. 27, 2021

(30) Foreign Application Priority Data
Mar. 11, 2021 (JP) 2021-039480

(51) Int. Cl. G06Q 30/02; G06F 30/10

(52) U.S. Cl. CPC G06Q 30/0283; G06F 30/10; G06F 2113/22

(57) ABSTRACT

An information processing apparatus includes a processor configured to specify a design element of a product, which affects cost of the product, from three-dimensional shape data of the product and a production requirement for the product and output a cost reduction measure for the product related to the design element of the product and an amount of reduced cost of the product that is obtained in a case where the cost reduction measure for the product is executed.

### CROSS-REFERENCE TO RELATED APPLICATIONS

This application is based on and claims priority under 35 USC 119 from Japanese Patent Application No. 2021-039480 filed Mar. 11, 2021.

### BACKGROUND

### (i) Technical Field

The present invention relates to an information processing apparatus and a non-transitory computer readable medium storing an information processing program.

### (ii) Related Art

JP5753621B discloses an estimation method including: a first step of importing the shape data of an item through an input terminal; a second step of recognizing the shape and dimensions of the item input to the input terminal on the basis of the shape data; a third step of acquiring manufacturing conditions including tolerance, which may be selected in a case where the item is manufactured, on the basis of the recognized shape and dimensions of the item; a fourth step of displaying manufacturing conditions on a display terminal so that the manufacturing conditions can be selected, and displaying a price or a delivery date corresponding to the displayed manufacturing conditions and a three-dimensional shape model of the item, to which and dimensions and tolerance are added, on the display terminal; and a fifth step of updates the price or the delivery date, which is displayed on the display terminal, and the dimensions and the tolerance added to the three-dimensional shape model according to a manufacturing condition selected through the input terminal.

### SUMMARY

An estimation method of estimating the cost of a product from the three-dimensional shape data of the product using a computer is known.

However, the estimated amount of the cost of the product is merely output in the estimation method in the related art. Accordingly, for example, in a case where the cost of the product exceeds target cost, a designer of the product changes the design of the product by trial and error to reduce the cost of the product to cost equal to or lower than the target cost.

Aspects of non-limiting embodiments of the present disclosure relate to an information processing apparatus and a non-transitory computer readable medium storing an information processing program that can notify a user of how to change the design of a product under design to reduce the cost of the product.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to specify a design element of a product, which affects cost of the product, from three-dimensional shape data of the product and a production requirement for the product and output a cost reduction measure for the product related to the design element of the product and an amount of reduced cost of the product that is obtained in a case where the cost reduction measure for the product is executed.

### BRIEF DESCRIPTION OF THE DRAWINGS

Exemplary embodiment(s) of the present invention will be described in detail based on the following figures, wherein:

FIG. 1 is a diagram showing a configuration example in which an information processing apparatus is formed using a computer;

FIG. 2 is a flowchart showing an example of the flow of estimation processing;

FIGS. 3A and 3B are schematic diagrams illustrating a mold clamping force of an injection molding machine;

FIG. 4 is a schematic diagram illustrating a mold size;

FIG. 5 is a schematic diagram illustrating an extraction stroke;

FIG. 6 is a diagram showing an example of an estimation screen;

FIG. 7 is a diagram showing an example of factors determining the cost of a product associated with press working;

FIG. 8 is a flowchart showing an example of the flow of drawing determination processing;

FIG. 9 is a diagram showing an example of the reference surface of a product;

FIG. 10 is a diagram showing an example of adjacent surfaces;

FIG. 11 is a diagram showing an example of adjacent surface groups;

FIG. 12 is a diagram showing an example of a situation where drawing determination processing is recursively executed;

FIG. 13 is a diagram showing an example of a drawing shape that is detected from the product;

FIG. 14 is a diagram showing an example of a drawing shape having an escape; and

FIG. 15 is a flowchart showing an example of the flow of additional drawing determination processing.

### DETAILED DESCRIPTION

An exemplary embodiment will be described below with reference to the drawings. The same components and the same processing are denoted by the same reference numerals over all the drawings, and the repeated description thereof will be omitted.

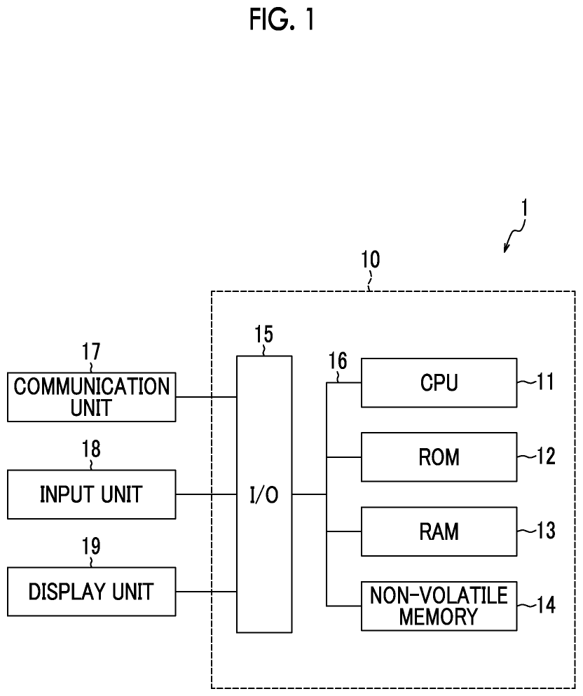

FIG. 1 is a diagram showing a configuration example in which an information processing apparatus 1 is formed using a computer 10. The information processing apparatus 1 outputs the three-dimensional shape data of a product 3, cost reduction measures related to the design elements of the product 3 from the production requirements for the product 3, and the amount of reduced cost of the product 3 that is obtained in a case where the cost reduction measures are executed.

The production requirements for the product 3 are manufacturing items required to manufacture the product 3. Specifically, the production requirements for the product 3 include, for example, a method of manufacturing the product 3, steps associated with manufacture, manufacturing facilities, a manufacturing site, human resource planning, a manufacturing period, the number of products to be manufactured, and the like.

The design elements of the product 3 are attributes related to the product 3 itself and attributes related to the setting of a manufacturing apparatus for manufacturing the product 3. Specifically, the design elements of the product 3 include, for example, the shape, dimensions, strength, color, material, accuracy, and the like of the product 3.

The computer 10 includes a central processing unit (CPU) 11 that is an example of a processor being in charge of executing the function of the information processing apparatus 1, a read only memory (ROM) 12 that stores an information processing program for causing the computer 10 to function as the information processing apparatus 1, a random access memory (RAM) 13 that is used as the temporary work area of the CPU 11, a non-volatile memory 14, and an input/output interface (I/O) 15. The CPU 11, the ROM 12, the RAM 13, the non-volatile memory 14, and the I/O 15 are connected to each other through a bus 16.

The non-volatile memory 14 is an example of a memory in which stored information is maintained even though power supplied to the non-volatile memory 14 is cutoff. For example, a semiconductor memory is used as the non-volatile memory 14, but a hard disk may be used. For example, a parameter, such as a threshold value, to be referred in a case where the CPU 11 executes the information processing program is stored in the non-volatile memory 14.

For example, a communication unit 17, an input unit 18, and a display unit 19 are connected to the I/O 15.

The communication unit 17 is connected to a communication line (not shown), and includes a communication protocol that performs data communication with an external device connected to the communication line. In the following description, for example, the CPU 11 acquires the three-dimensional shape data of the product 3 from the external device through the communication unit 17.

The input unit 18 is a unit that receives an instruction given from a user and notifies the instruction to the CPU 11. For example, a button, a touch panel, a keyboard, a pointing device, a mouse, and the like are used as the input unit 18.

The display unit 19 is a unit that visually outputs information processed by the CPU 11. For example, a liquid crystal display, an organic electro luminescence (EL) display, and a display device, such as a projector projecting a video onto a screen, are used as the display unit 19.

The computer 10 may be formed using cloud computing. In this case, the computer 10 is remotely operated from an external device through a communication line. Accordingly, the input unit 18 and the display unit 19 are not necessarily required for the computer 10.

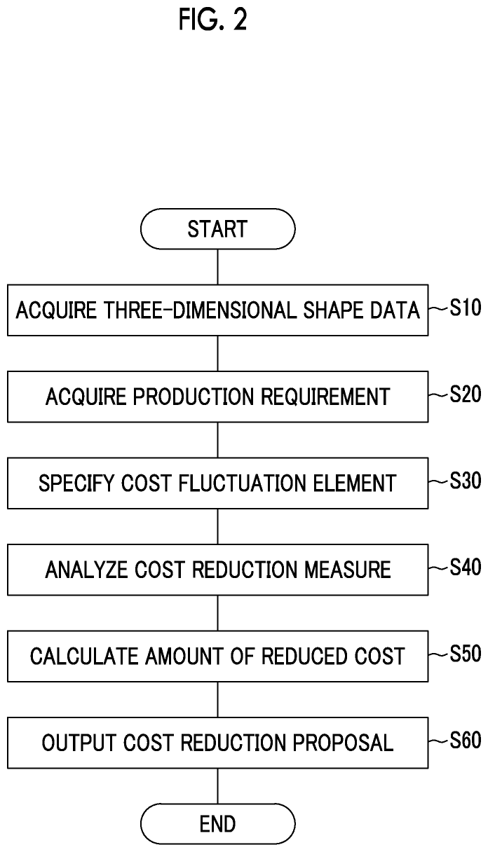

Next, the action of the information processing apparatus 1 will be described in detail. FIG. 2 is a flowchart showing an example of the flow of estimation processing that is executed by the CPU 11 of the information processing apparatus 1 in a case where, for example, an estimation instruction for the product 3 is received from a user.

An information processing program defining the estimation processing is stored in, for example, the ROM 12 of the information processing apparatus 1 in advance. The CPU 11 of the information processing apparatus 1 reads the information processing program stored in the ROM 12, and executes the estimation processing.

First, in Step S10, the CPU 11 acquires the three-dimensional shape data of a product 3, which is an object to be estimated, from the external device through the communication unit 17 and stores the three-dimensional shape data in the RAM 13. A method of acquiring the three-dimensional shape data of the product 3 is not limited thereto. For example, the three-dimensional shape data of the product 3 may be acquired from a field-portable semiconductor memory, such as a universal serial bus (USB) memory and a memory card.

In Step S20, the CPU 11 acquires the production requirements for the product 3, which are represented by the three-dimensional shape data acquired in Step S10, and stores the production requirements in the RAM 13. The production requirements may be acquired from the external device through the communication unit 17, or may be acquired from a field-portable semiconductor memory.

In Step S30, the CPU 11 estimates the product 3 from the three-dimensional shape data of the product 3, which is acquired in Step S10, and the production requirements for the product 3, which are acquired in Step S20, using a publicly-known estimation method and specifies design elements affecting the cost of the product 3, that is, “cost fluctuation elements” from the production requirements for the product 3.

For example, it is assumed that the material of the product 3 is a plastic resin and production requirements in which and the product 3 is manufactured by injection molding machine 2 using a mold 4 are acquired. In a case where a plastic resin is injection-molded by an injection molding machine 2 to manufacture the product 3, a requirement having a large influence on the cost of the product 3 is the molding machine tonnage of the injection molding machine 2.

The molding machine tonnage is a force for clamping the mold 4 for the product 3, and is defined for each injection molding machine 2 in advance. The injection molding machine 2 having a larger molding machine tonnage can manufacture a larger product 3. However, as the molding machine tonnage is increased, for example, the rental rate of the injection molding machine 2 is increased and time required for manufacturing preparation and time required for purging, which forms the cycle time of the product 3, are also lengthened. For this reason, the cost of the product 3 determined in consideration of not only manufacturing facilities to be used but also labor cost is increased. The rental rate of the injection molding machine 2 is also called “charge”, and includes the depreciation cost of the injection molding machine 2 and heating and lighting cost required for the manufacture of the product 3.

As described above, among items determining the cost of the product 3 from the viewpoint of production requirements, an item most affecting the cost of the product 3 is called a “cost requirement” and is predetermined for each production requirement. For example, it is preferable that an item, which is more difficult to be conscious by a designer of the product 3 than other items in a step of designing the product 3, is selected as a cost requirement associated with production requirements.

The CPU 11 specifies design elements to be changed to reduce the cost of the product 3 among a plurality of design elements that are associated with each cost requirement (in this case, molding machine tonnage) in advance.

For example, the molding machine tonnage of the injection molding machine 2 is determined depending on a force for clamping the mold 4 (referred to as a “mold clamping force”), the size of the mold 4 to be used (referred to as a “mold size”), and the movement distance of the mold clamping unit 22 (referred to as an “extraction stroke”). For the convenience of description, a mold clamping force, a mold size, and an extraction stroke are referred to as “cost determinants” in a case where the cost requirement is the molding machine tonnage.

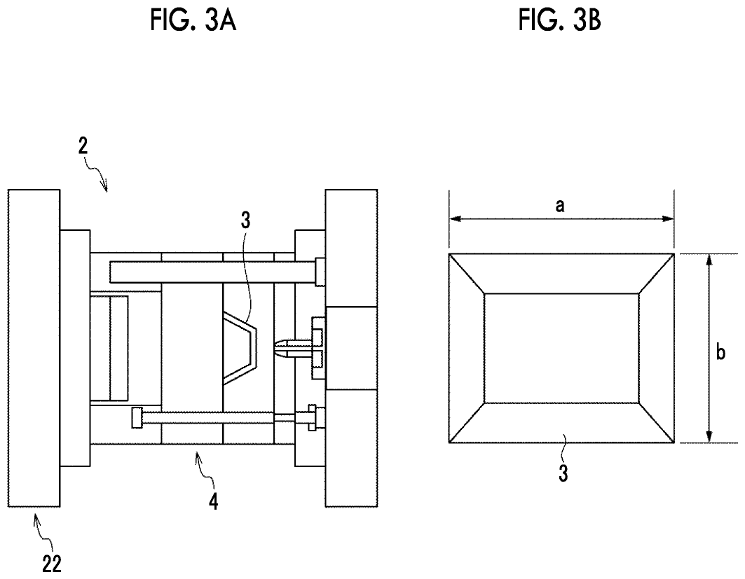

FIGS. 3A and 3B are schematic diagrams illustrating the mold clamping force of the injection molding machine 2. As shown in FIG. 3A, in a case where injection molding is performed by the injection molding machine 2, the mold 4 is fixed by the mold clamping unit 22 so that the parting surface of the mold 4 is not opened by filling pressure generated in a case where a plastic resin is injected to the mold 4 from a nozzle. A force required to clamp the mold 4 is a mold clamping force.

A mold clamping force is affected by the respective design elements, such as the projected area of the product 3, the presence or absence of a slide, and the molding pressure of a plastic resin. Accordingly, the projected area of the product 3, the presence or absence of a slide, and the molding pressure of a plastic resin are associated with a mold clamping force, which is one of the cost determinants of the molding machine tonnage, in advance as design elements that determine cost.

As shown in FIG. 3B, the projected area of the product 3 is represented by the area of a shadow that can be obtained in a case where the surface of the product 3 disposed at a position orthogonal to a nozzle for injecting a plastic resin in the injection molding machine 2 is illuminated with light from the front. In the case of the product 3 shown in FIG. 3B, a projected area is obtained from (axb).

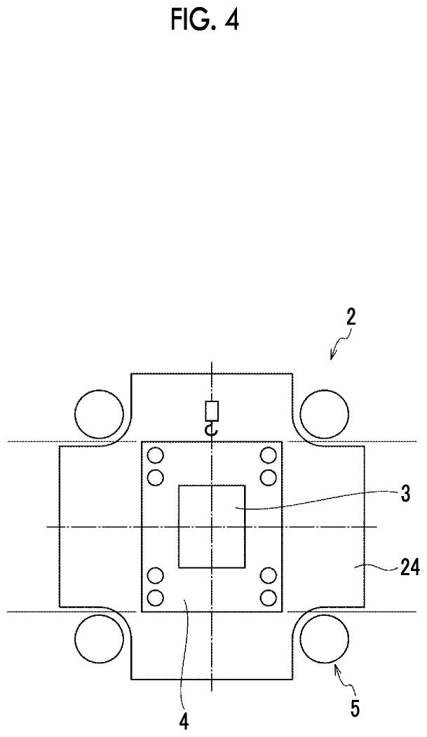

FIG. 4 is a schematic diagram illustrating a mold size. The mold 4 for the product 3 is fixed to a molding machine-die plate 24 provided in a space surrounded by tie bars 5. However, since a larger product 3 is obtained as the size of the mold 4 is increased, an injection molding machine 2 having larger molding machine tonnage is required with an increase in the size of the product.

A mold size is affected by the respective design elements, such as the size of the product 3, the shape of the product 3, and a slide stroke. The slide stroke is a distance where the mold clamping unit 22 is drawn that is required in a case where the product 3 is to be extracted from the injection molding machine 2. Accordingly, the size of the product 3, the shape of the product 3, and a slide stroke are associated with a mold size, which is one of the cost determinants of the molding machine tonnage, in advance as design elements that determine cost.

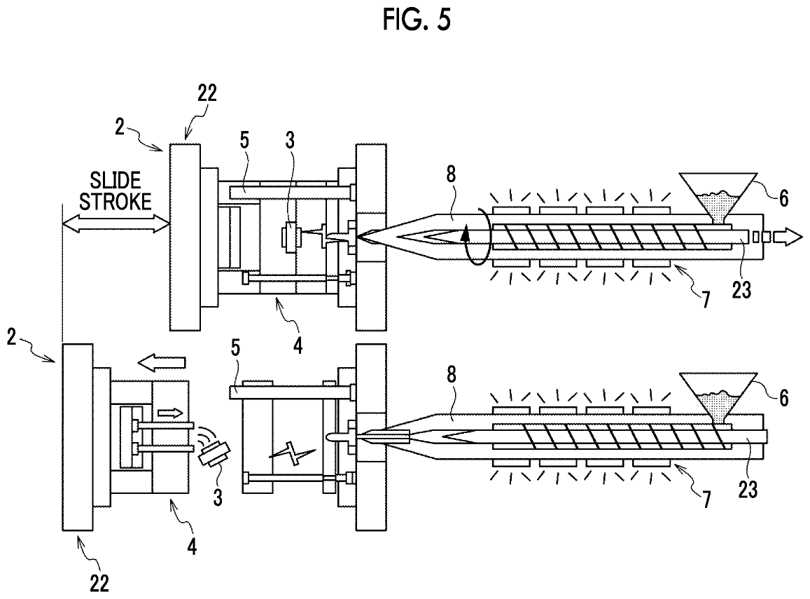

FIG. 5 is a schematic diagram illustrating an extraction stroke. A heating cylinder 8 of the injection molding machine 2 is heated by a heater 7. Accordingly, in a case where the injection molding machine 2 extrudes a plastic resin, which is put into a hopper 6, to the front side of the heating cylinder 8 while rotating a screw 23, the plastic resin melted by the heat of the heater 7 is injected to the mold 4. As a result, the product 3 is molded.

The molded product 3 is extracted from the mold 4 in a case where the mold clamping unit 22 is moved, but the maximum value of the movement distance of the mold clamping unit 22 is an extraction stroke. Since the injection molding machine 2 having a longer extraction stroke can manufacture a larger product 3, the molding machine tonnage of the injection molding machine 2 is also increased necessarily.

An extraction stroke is affected by the respective design elements, such as the size of the product 3 and a slide stroke. Accordingly, the size of the product 3 and a slide stroke are associated with an extraction stroke, which is one of the cost determinants of the molding machine tonnage, in advance as design elements that determine cost.

The association of the design elements with each cost determinant is stored in, for example, the non-volatile memory 14 in advance.

Accordingly, the CPU 11 estimates cost requirements, which are to be calculated from the design elements associated with the cost determinants, for each cost determinant using the three-dimensional shape data of the product 3, which is acquired in Step S10, with reference to the design elements associated with the respective cost determinants. In the case of injection molding using a plastic resin, the CPU 11 estimates molding machine tonnage that is required for each of a mold clamping force, a mold size, and an extraction stroke.

Moreover, the CPU 11 estimates cost determinants that limit cost requirements, and specifies design elements, which are associated with the cost determinants limiting the cost requirements, as cost fluctuation elements.

For example, it is assumed that molding machine tonnage estimated from the design elements associated with a mold clamping force is 160 ton, molding machine tonnage estimated from the design elements associated with a mold size is 80 ton, and molding machine tonnage estimated from the design elements associated with an extraction stroke is 50 ton. In this case, in order to manufacture the product 3, an injection molding machine 2 having a molding machine tonnage of at least 160 ton should be used. That is, a mold clamping force is a limiting element that limits the molding machine tonnage of the injection molding machine 2.

Accordingly, the CPU 11 specifies design elements, which are associated with a mold clamping force, as cost fluctuation elements.

In Step S40 of FIG. 2, the CPU 11 analyzes how the cost requirements are changed in a case where what kind of design change is made with respect to the cost fluctuation elements specified in Step S30, using the three-dimensional shape data of the product 3. Moreover, the CPU 11 detects, for example, proposed changes of cost fluctuation elements, which can correspond to cost requirements where the cost of the product 3 is reduced, as a cost reduction measure. There may be a plurality of cost reduction measures, and the CPU 11 may detect cost reduction measures, which most reduce the cost of the product 3, for the cost fluctuation elements that are associated with the cost determinants limiting the cost requirements, respectively.

In Step S50, the CPU 11 calculates the amount of reduced cost of the product 3 that is obtained in a case where the cost reduction measure detected in Step S40 is executed for the three-dimensional shape data of the product 3 acquired in Step S10. In a case where there are a plurality of cost reduction measures, the CPU 11 calculates the amount of reduced cost of the product 3 for each of the cost reduction measures.

In Step S60, the CPU 11 outputs the estimation of the product 3 calculated from the current three-dimensional shape data and the production requirements and outputs the cost reduction measure, which is detected in Step S40, together with the amount of reduced cost of the product 3, which is calculated in Step S50, in association with a cost requirement that is changed in a case where the cost reduction measure is executed.

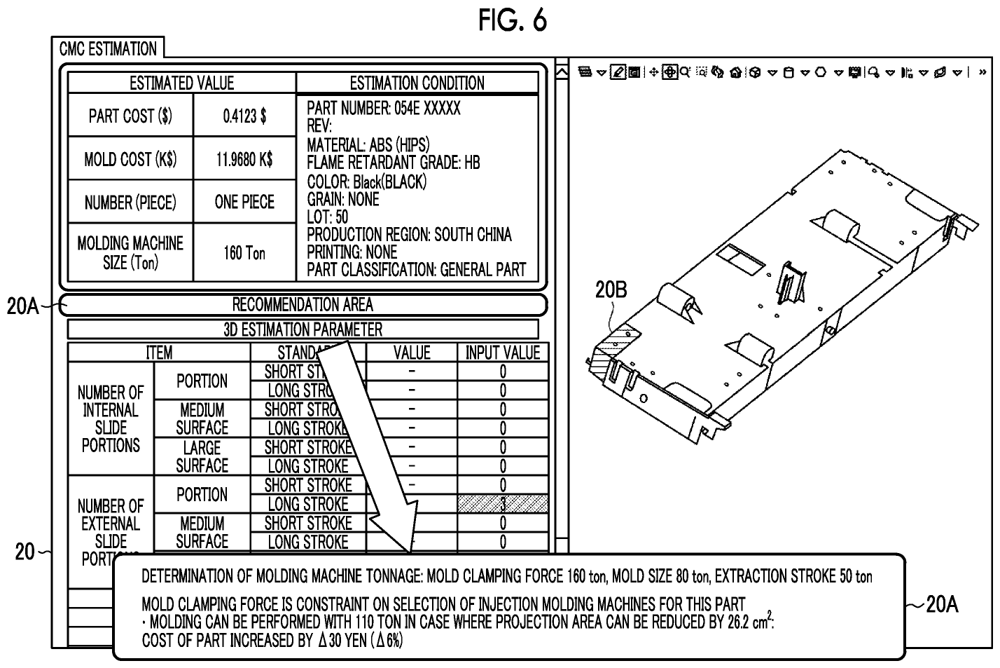

FIG. 6 is a diagram showing an example of an estimation screen 20 that shows the estimation results of the product 3. A recommendation area 20A, which displays the proposed changes of design elements to be recommended to a user for a reduction in the cost of the product 3 represented by the acquired three-dimensional shape data, is provided on the estimation screen 20. A cost requirement for each cost determinant that is estimated from the design elements associated with the cost determinants and is obtained before the cost reduction measure is executed, the cost reduction measure, and the change state of the cost requirements and the amount of reduced cost that are obtained in a case where the cost reduction measure is executed are displayed in the recommendation area 20A.

In the case of FIG. 6 that is an example of the estimation screen 20 for the product 3 manufactured by the injection molding machine 2, the recommendation area 20A displays that the current molding machine tonnage obtained before the execution of cost reduction measures estimated in terms of a mold clamping force, a mold size, and an extraction stroke, which are the cost determinants, is 160 ton, 80 ton, and 50 ton, respectively.

Further, at least one of a fact that a mold clamping force is a constraint on the selection of an injection molding machine 2, that is, a limiting element of a cost requirement, a design change that reduces the projected area of the product 3 by about 26.2 cm², that is, a cost reduction measure for the cost fluctuation element, molding machine tonnage that can be reduced by the execution of the cost reduction measure, that is, a change in the cost requirement caused by the cost reduction measure, or a fact that part cost is reduced by 30 yen (6%) due to the cost reduction measure, that is, the amount of reduced cost or a cost reduction ratio is displayed in the recommendation area 20A. A change in the cost requirement caused by the cost reduction measure is an example of information about a change in the production requirements for the product.

In a case where a plurality of cost reduction measures are displayed in the recommendation area 20A, the CPU 11 may arrange and display the plurality of cost reduction measures in a recommended order. For example, the amount of reduced cost, the weight of the product 3, and the number of similar cost reduction measures actually executed in the past, that is, an achieved value for each cost reduction measure are used as the viewpoint of recommending the cost reduction measures by the CPU 11.

Further, the CPU 11 may display a position corresponding to a design element, which is proposed to be changed by the cost reduction measure, on the three-dimensional shape data of the product 3, and may output the position together with the cost reduction measure. In a case of the example of FIG. 6, the CPU 11 specifies a position of a deleted portion 20B, which would be better to be deleted in order to reduce the projected area of the product 3 by about 26.2 cm², and displays the position on the three-dimensional shape data. The CPU 11 notifies a user of the deleted portion 20B by changing the color of the deleted portion 20B or illustrating the range of the deleted portion 20B.

With the above, the estimation processing shown in FIG. 2 ends. The CPU 11 displays the estimation screen 20 on the display unit 19 as a form where the CPU 11 outputs the estimation results of the product 3, but may transmit the estimation screen 20 to an external device through the communication unit 17 to display the estimation screen 20 on the screen of the external device. A form where the CPU 11 stores the estimation results in the non-volatile memory 14 or the memory of the external device as data, a form where the CPU 11 notifies a user the estimation results by voice, and a form where the CPU 11 prints the estimation results on a sheet by a printer are also be an example of an output form where the CPU 11 outputs a cost reduction measure for the product 3 or the amount of reduced cost.

Up to here, the estimation processing of the information processing apparatus 1 has been described using the manufacture of the product 3, which is performed by the injection molding machine 2, by way of example. However, the estimation processing shown in FIG. 2 is applied even in a case where there is no constraint on production requirements premising the manufacture of the product 3 and the product 3 is manufactured by, for example, a press.

A cost requirement in a case where the product 3 is manufactured by a press is the number of processes of press working required to manufacture the product 3 (hereinafter, referred to as “the number of press processes”). As the number of press processes is increased, the cost of the product 3 is increased. However, a designer of the product 3 rarely designs the product 3 while being conscious of the number of press processes in a step of designing the product 3.

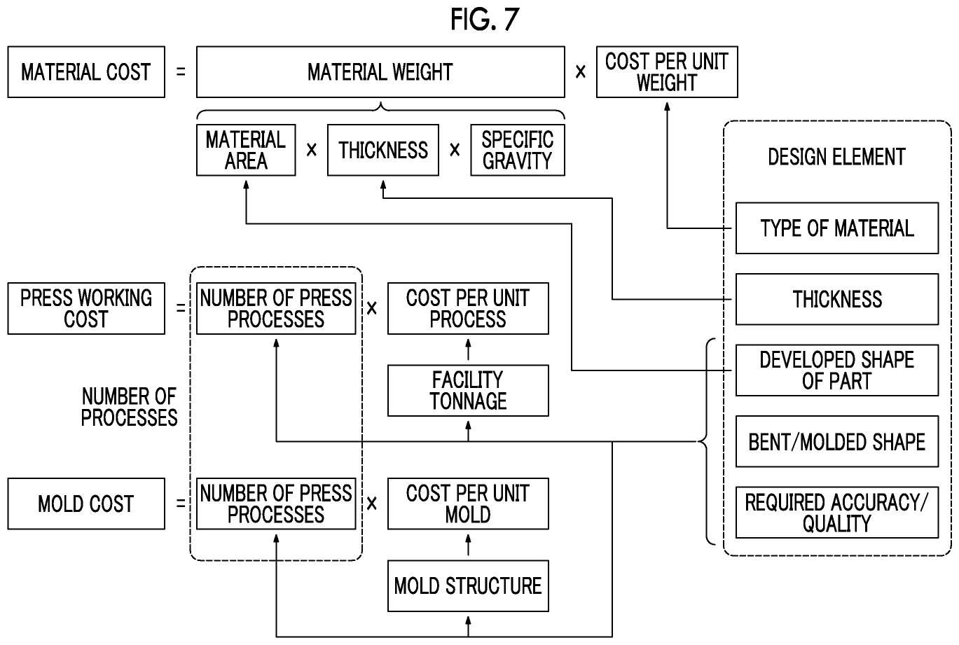

FIG. 7 is a diagram showing an example of factors determining the cost of the product 3 associated with press working. As shown in FIG. 7, the number of press processes affects the press working cost and mold cost of the product 3. Further, the number of press processes is determined depending on design elements that affect, for example, the developed shape of a part, a bent shape, a molded shape, required accuracy, and a required quality.

Accordingly, the number of press processes can be reduced in a case where the design elements affecting the number of press processes are changed. As a result, the cost of the product 3 is reduced. That is, the design elements affecting the number of press processes are design elements associated with the number of press processes that is a cost requirement.

The design elements affecting the number of press processes include, for example, 25 items, that is, the presence or absence of a request for surface pressing, the outer perimeter of the product 3, the presence or absence of an opening of a drawing surface, the number of drawing portions, the number of bends bent at an acute angle, the length of a slit, the width of a slit, a drawing direction, a drawing area, the number of step bends, a drawing height, a drawing distance and a punching distance, the perimeter of a hole, the number of hems, a diagonal size, the presence or absence of embossing, the number of holes, the presence or absence of an opening of a drawing slope, a longitudinal side and a lateral side, the number of curls, the presence or absence of a louver, the presence or absence of burring, the presence or absence of deep drawing, the presence or absence of an embossment to be caught in a punch, and free flatness.

There are 2112 patterns as all process patterns to be obtained from the combinations of the design elements of these 25 items. Accordingly, in Step S30 of FIG. 2, the CPU 11 extracts process patterns in which the number of press processes is smaller than the number of current press processes required to manufacture the product 3, that is, “similar process patterns” from the 2112 process patterns.

Specifically, it is assumed that the number of press processes (corresponding to “the number of current press processes”), which is estimated from the three-dimensional shape data of the product 3 to be estimated, corresponds to three processes of drilling, bending, and drawing. In this case, the CPU 11 extracts process patterns, which match process patterns in a case where the number of current press processes is reduced by one, from all the process patterns as similar process patterns. That is, process patterns in which bending and drawing, drilling and drawing, and drilling and bending are combined are similar process patterns, and each of the design elements of the similar process patterns is a cost fluctuation element.

Since each of the similar process patterns limits the number of press processes, each of the similar process patterns is also an example of a cost determinant.

In Step S40 of FIG. 2, the CPU 11 analyzes how the cost requirements are changed in a case where what kind of design change is made with respect to the cost fluctuation elements of each similar process pattern, using the three-dimensional shape data of the product 3. Moreover, the CPU 11 detects, for example, proposed changes of cost fluctuation elements, which can correspond to cost requirements for allowing the cost of the product 3 to be reduced, as a cost reduction measure for each similar process pattern.

Accordingly, the CPU 11 calculates the amount of reduced cost of the product 3 that is obtained in a case where the cost reduction measure detected in Step S40 for each similar process pattern is performed; and displays the number of current press processes, which is obtained before the cost reduction measure is executed, the cost reduction measure, and the number of press processes and the amount of reduced cost, which are obtained after the cost reduction measure is executed, in the recommendation area 20A of the estimation screen 20 shown in FIG. 6.

For example, the CPU 11 displays information, such as “the number of press processes for the current product is three but the number of press processes can be reduced by the improvement of a shape to be described below. (1) Since drilling can be omitted and one process can be reduced in a case where a drawing distance and a punching distance can be set to 5 mm or more, press working cost can be reduced by 100 yen (3%) and mold cost can be reduced by 500 yen (5%). (2) Since bending can be omitted and one process can be reduced in a case where a drawing height can be reduced by 10 mm, press working cost can be reduced by 120 yen (3.6%) and mold cost can be reduced by 300 yen (3%) . . . ” in the recommendation area 20A, and notifies a user of design elements that contribute to a reduction in the number of press processes by a change in design.

Press working includes working called “drawing” that forms a three-dimensional shape after keeping a change in the thickness of a plate within a predetermined range. Until now, humans have used three-dimensional shape data to determine whether or not there is a shape requiring drawing, that is, a “drawing shape” in the product 3 represented by three-dimensional shape data. However, since some drawing shapes do not look like drawing shapes in a case where a user does not look closely, it often takes time to determine a drawing area and a drawing height. Therefore, determination accuracy and determination time for drawing vary depending on the experience and knowledge of a user who confirms a drawing shape.

On the other hand, in the information processing apparatus 1 according to this exemplary embodiment, the CPU 11 determines the presence or absence of a drawing shape from the three-dimensional shape data of the product 3 in the estimation processing shown in FIG. 2 in a case where a press is used to manufacture the product 3.

Drawing determination processing of determining whether or not the product 3 includes a drawing shape in a case where a press is used to manufacture the product 3 in the estimation processing shown in FIG. 2 will be described below. The drawing determination processing is used, for example, in a situation where the presence or absence of a drawing shape is determined in order to specify cost fluctuation elements in Step S30 of the estimation processing shown in FIG. 2.

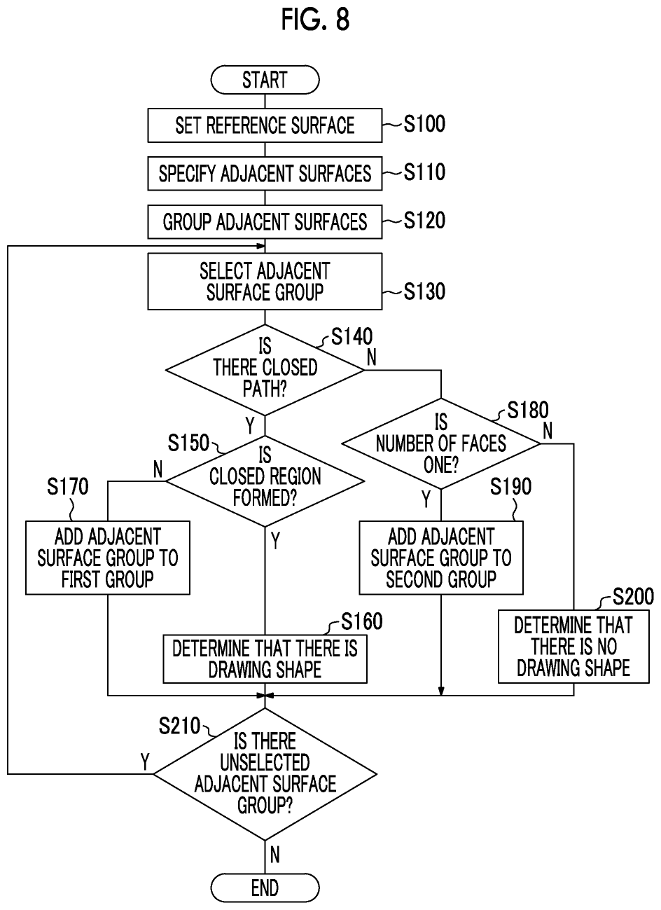

FIG. 8 is a flowchart showing an example of the flow of the drawing determination processing that is executed by the CPU 11 of the information processing apparatus 1.

An information processing program defining the drawing determination processing is stored in, for example, the ROM 12 of the information processing apparatus 1 in advance. The CPU 11 of the information processing apparatus 1 reads the information processing program stored in the ROM 12, and executes the drawing determination processing.

In Step S100, the CPU 11 sets a reference surface 3A for the product 3 that is represented by the three-dimensional shape data.

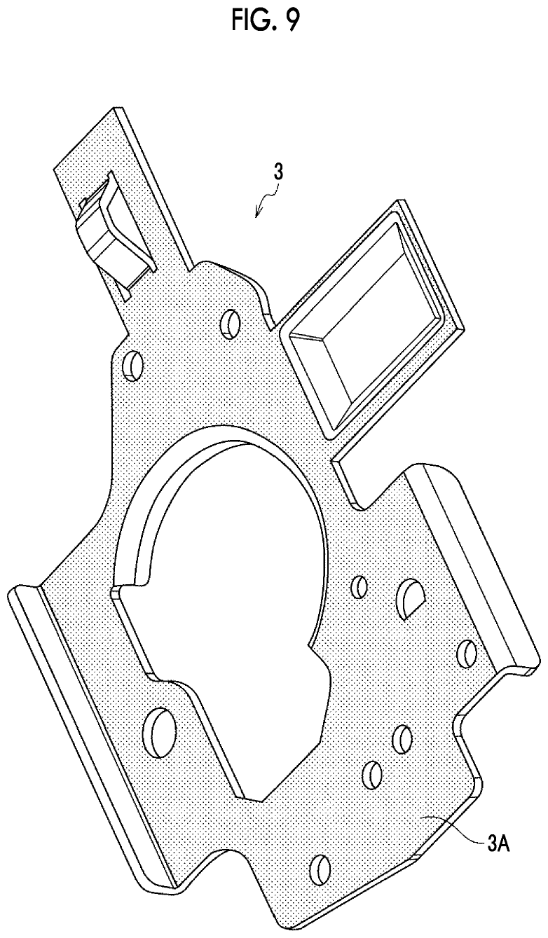

FIG. 9 is a diagram showing an example of the reference surface 3A of the product 3. The CPU 11 sets, for example, an uneven surface or a surface including a hole as the reference surface 3A among the surfaces of the product 3.

In Step S110, the CPU 11 specifies adjacent surfaces 3B adjacent to the reference surface 3A. The adjacent surfaces 3B adjacent to the reference surface 3A are surfaces that are adjacent to the reference surface 3A so as to form angles with respect to the reference surface 3A, and may be curved surfaces or flat surfaces.

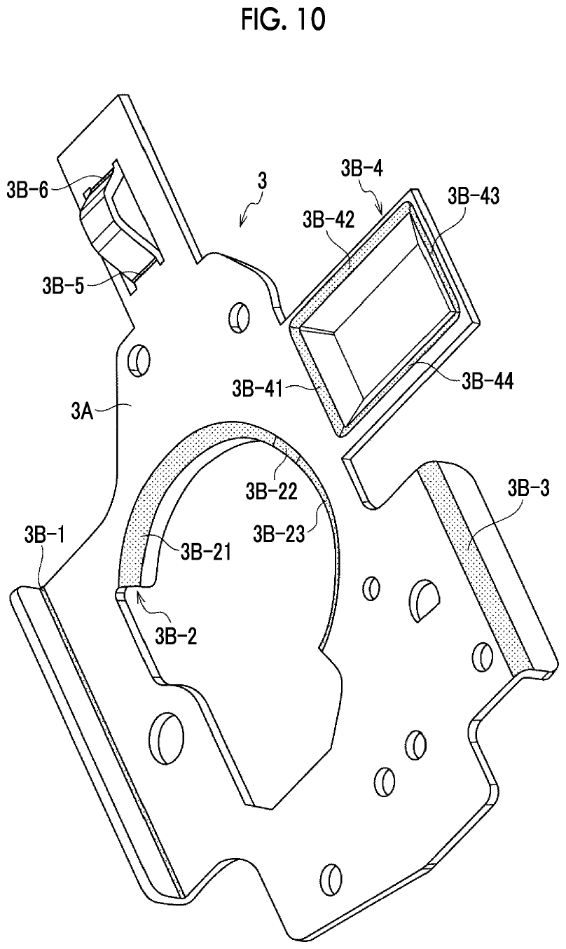

FIG. 10 is a diagram showing an example of the adjacent surfaces 3B. In the case of the shape of the product 3 shown in FIG. 10, an adjacent surface 3B-1, an adjacent surface 3B-2, an adjacent surface 3B-3, an adjacent surface 3B-4, an adjacent surface 3B-5, and an adjacent surface 3B-6 are specified as the adjacent surfaces 3B. Among these adjacent surfaces, each of the adjacent surface 3B-2 and the adjacent surface 3B-4 is formed of a plurality of adjacent surfaces 3B. The respective adjacent surfaces 3B forming the adjacent surface 3B-2 are an adjacent surface 3B-21, an adjacent surface 3B-22, and an adjacent surface 3B-23, and the respective adjacent surfaces 3B forming the adjacent surface 3B-4 are an adjacent surface 3B-41, an adjacent surface 3B-42, an adjacent surface 3B-43, and an adjacent surface 3B-44.

In a case where the adjacent surfaces 3B are individually described in this way, “-N” (N is an integer) is added behind the reference numeral of each adjacent surface 3B so that the adjacent surfaces 3B are distinguished from each other.

In Step S120, the CPU 11 groups the adjacent surfaces 3B adjacent to each other and creates adjacent surface groups 9.

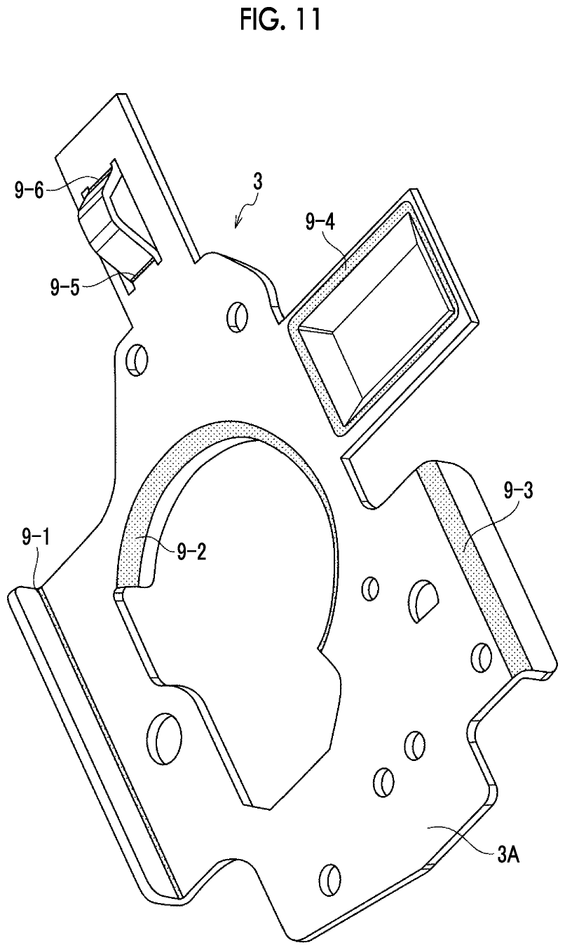

FIG. 11 is a diagram showing an example in which the adjacent surfaces 3B shown in FIG. 10 are grouped into the adjacent surface groups 9. In the example shown in FIG. 10, the adjacent surface 3B-21, the adjacent surface 3B-22, and the adjacent surface 3B-23 are grouped into an adjacent surface group 9-2, and the adjacent surface 3B-41, the adjacent surface 3B-42, the adjacent surface 3B-43, and the adjacent surface 3B-44 are grouped into an adjacent surface group 9-4. The adjacent surface 3B-1, the adjacent surface 3B-3, the adjacent surface 3B-5, and the adjacent surface 3B-6, which do not include the adjacent surfaces 3B adjacent thereto, form an adjacent surface group 9-1, an adjacent surface group 9-3, an adjacent surface group 9-5, and an adjacent surface group 9-6, each of which is one adjacent surface 3B, respectively.

In a case where the groups 9 are individually described in this way, “-N” is added behind the reference numeral of each group 9 so that the groups 9 are distinguished from each other. Further, each of the adjacent surfaces 3B forming the adjacent surface groups 9 may be referred to as a “face”.

In Step S130, the CPU 11 selects any one adjacent surface group 9 among the adjacent surface groups 9 created in Step S120. For the convenience of description, the adjacent surface group 9 selected in Step S130 is referred to as a “selected adjacent surface group 9” in the description of the drawing determination processing.

The CPU 11 determines in Step S140 whether or not there is a closed path in the selected adjacent surface group 9. The “closed path” is a path that makes a round through only the adjacent surface group 9 without turning back. In a case where there is a closed path, the processing proceeds to Step S150.

The CPU 11 determines in Step S150 whether or not a closed region is formed by the selected adjacent surface group 9. The “closed region” is a region where the entire inside of a range surrounded by the closed path is covered with a surface. Since a fact that the closed region is formed means that drilling or bending cannot be performed, the selected adjacent surface group 9 represents a drawing shape.

Accordingly, in a case where the closed region is formed by the selected adjacent surface group 9, the processing proceeds to Step S160 and the CPU 11 determines in Step S160 that there is a drawing shape in a range including the selected adjacent surface group 9.

On the other hand, in a case where the closed region is not formed by the selected adjacent surface group 9, the processing proceeds to Step S170. In this case, since there is a possibility that the selected adjacent surface group 9 represents a part of a drawing shape, the CPU 11 adds the selected adjacent surface group 9 to a first group. The “first group” is a set of adjacent surface groups 9 that need to be subjected to the recursive execution of the drawing determination processing shown in FIG. 8 as described later to further determine whether or not there is a drawing shape.

In a case where it is determined in the determination processing of Step S140 that there is no closed path in the selected adjacent surface group 9, the processing proceeds to Step S180.

The CPU 11 determines in Step S180 whether or not the number of adjacent surfaces 3B included in the selected adjacent surface group 9, that is, the number of faces is one. Ina case where the number of faces is one, there is a possibility that the selected adjacent surface group 9 represents a part of a drawing shape even though there is no closed path in the selected adjacent surface group 9.

Accordingly, the processing proceeds to Step S190 and the CPU 11 adds the selected adjacent surface group 9 to a second group in Step S190. The “second group” is a set of adjacent surface groups 9 that is likely to represent a part of a drawing shape including an escape as described later.

In a case where it is determined in the determination processing of Step S180 that there are a plurality of faces in the selected adjacent surface group 9, the processing proceeds to Step S200.

In this case, since the selected adjacent surface group 9 does not represent a part of a drawing shape, the CPU 11 determines in Step S200 that there is no drawing shape in a range including the selected adjacent surface group 9.

After the processing of Steps S160, S170, S190, and S200 are executed, the CPU 11 determines in Step S210 whether or not there is an unselected adjacent surface group 9 not yet selected in Step S130 among the adjacent surface groups 9 created in Step S120.

In a case where there is an unselected adjacent surface group 9, the processing proceeds to Step S130 and the CPU 11 selects the unselected adjacent surface group 9 in Step S130 among the adjacent surface groups 9 created in Step S120 and updates the selected adjacent surface group 9. That is, the CPU 11 repeatedly executes Steps S130 to S210 until the CPU 11 determines in the determination processing of Step S210 that there is no unselected adjacent surface group 9; and executes any one of processing of determining that there is a drawing shape in each adjacent surface group 9, processing of determining that there is no drawing shape in each adjacent surface group 9, processing of adding each adjacent surface group 9 to the first group, or processing of adding each adjacent surface group 9 to the second group.

Moreover, in a case where it is determined in the determination processing of Step S210 that there is no unselected adjacent surface group 9, the drawing determination processing shown in FIG. 8 ends.

By the drawing determination processing, the adjacent surface group 9-1, the adjacent surface group 9-3, the adjacent surface group 9-5, and the adjacent surface group 9-6 among the adjacent surface groups 9 shown in FIG. 11 are classified into the second group, it is determined that there is no drawing shape in a portion represented by the adjacent surface group 9-2, and the adjacent surface group 9-4 is classified into the first group.

In a case where there are adjacent surface groups 9 added to the first group, the CPU 11 recursively executes the drawing determination processing shown in FIG. 8 for each of the adjacent surface groups 9 added to the first group. In this case, in Step S100 of FIG. 8, the CPU 11 sets the adjacent surface groups 9 added to the first group to the reference surface 3A and deletes the adjacent surface groups 9 set to the reference surface 3A from the first group. That is, the CPU 11 determines the presence or absence of a drawing shape using new adjacent surface groups 9 that include adjacent surfaces adjacent to the adjacent surface groups 9 added to the first group.

In the recursive processing of the drawing determination processing, in a case where it is determined in the determination processing of Step S140 that there is no closed path in the selected adjacent surface group 9, the processing proceeds to Step S200 without the execution of the determination processing of Step S180 and it is determined that there is no drawing shape in a range including the selected adjacent surface group 9. That is, adjacent surface groups 9 adjacent to the adjacent surface groups 9, which are classified into the first group once, are not classified into the second group. Further, in Step S110, the CPU 11 is adapted not to specify the adjacent surfaces 3B, which have been already specified in the previous drawing determination processing, as the adjacent surfaces 3B.

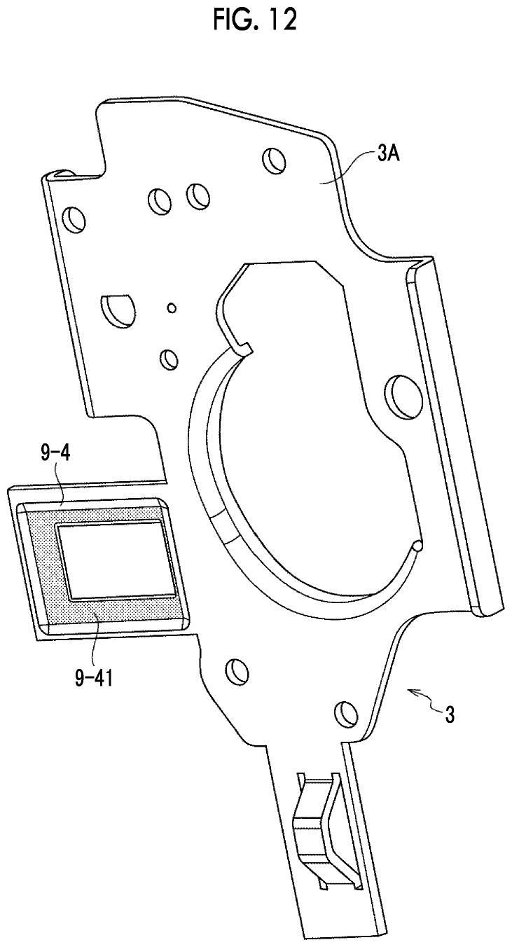

FIG. 12 is a diagram showing an example of a situation where the drawing determination processing is executed again for an adjacent surface group 9 added to the first group. In this case, an adjacent surface group 9-41 adjacent to the adjacent surface group 9-4 is added to the first group 9 as shown in FIG. 12.

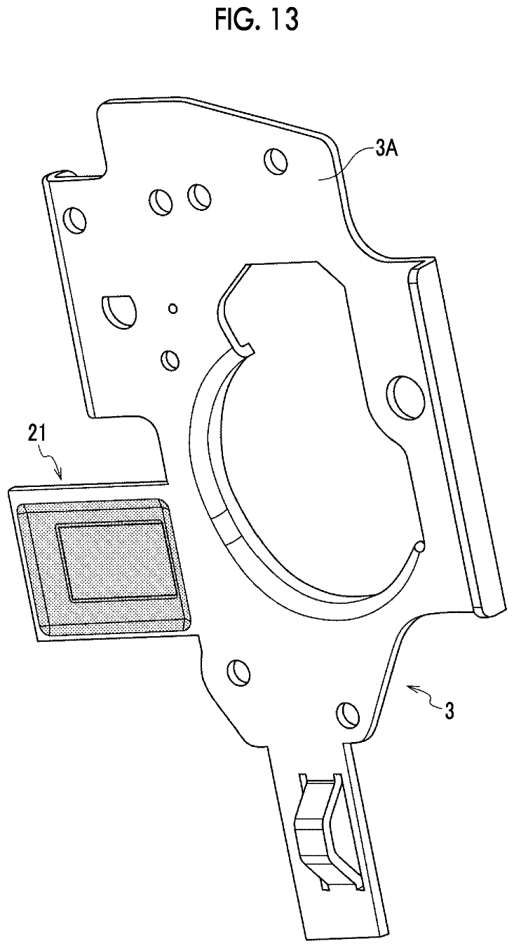

In a case where the drawing determination processing is recursively executed for the adjacent surface group 9 classified into the first group in the way, a specific portion 21, which is represented by each of the adjacent surface groups 9 recursively adjacent to the adjacent surface group 9 in which it is determined that there is a drawing shape, is detected as a drawing shape as shown in FIG. 13. “The adjacent surface groups 9 are recursively adjacent” represents a situation where other adjacent surface groups 9 are adjacent to the adjacent surface groups 9 adjacent to the adjacent surface group 9 until there is no adjacent surface group 9.

Next, processing for the second group will be described.

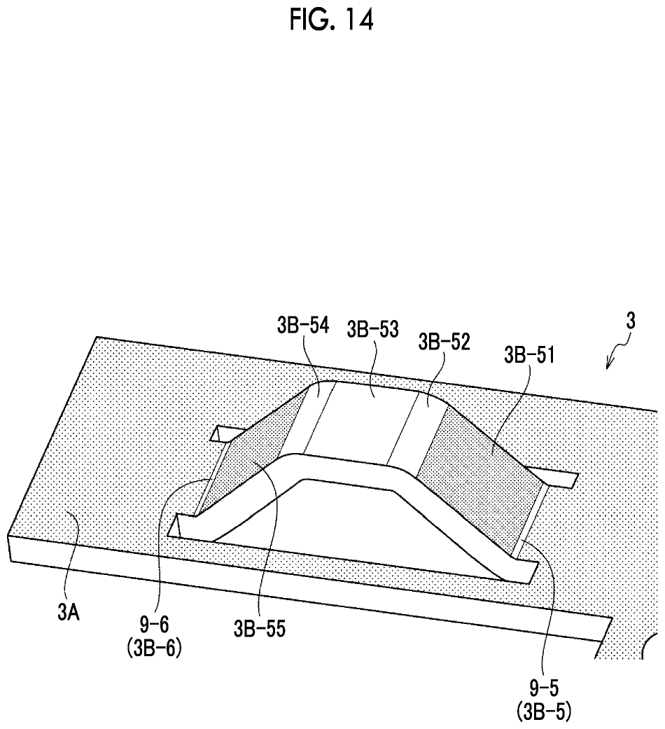

FIG. 14 is an enlarged view showing a portion of the product 3 that includes the adjacent surface group 9-5 and the adjacent surface group 9-6 of FIG. 11.

Since there is no closed path in the adjacent surface group 9-5 and the adjacent surface group 9-6, it is not determined in the drawing determination processing shown in FIG. 8 that the adjacent surface group 9-5 and the adjacent surface group 9-6 represent apart of a drawing shape. However, the shape shown in FIG. 14 is so-called “a drawing shape having an escape”, and is classified into a drawing shape.

The adjacent surface groups 9 of this drawing shape having an escape have characteristics in which the number of faces, that is, adjacent surfaces 3B forming each adjacent surface group 9 is one, an angle between the adjacent surfaces 3B adjacent to each other is within a reference angle, and a surface returns to the reference surface 3A of the product 3 in a case where the surface follows the adjacent surface 3B.

The “reference angle” of the drawing shape having an escape is an angle other than an angle seen in a situation where adjacent surfaces 3B adjacent to each other are orthogonal to each other or adjacent to each other without making an angle, and is set to, for example, 20° or more and 70° or less. The reference angle is stored in the non-volatile memory 14 in advance, and can be changed by a user.

A shape in which the adjacent surfaces 3B adjacent to each other are adjacent to each other at an angle exceeding the range of the reference angle can be realized by, for example, even working using bending instead of drawing. Accordingly, the determination of an angle between the adjacent surfaces 3B, which are adjacent to each other, for each of the adjacent surfaces 3B is one of determination conditions that are used to determine the presence or absence of the drawing shape having an escape.

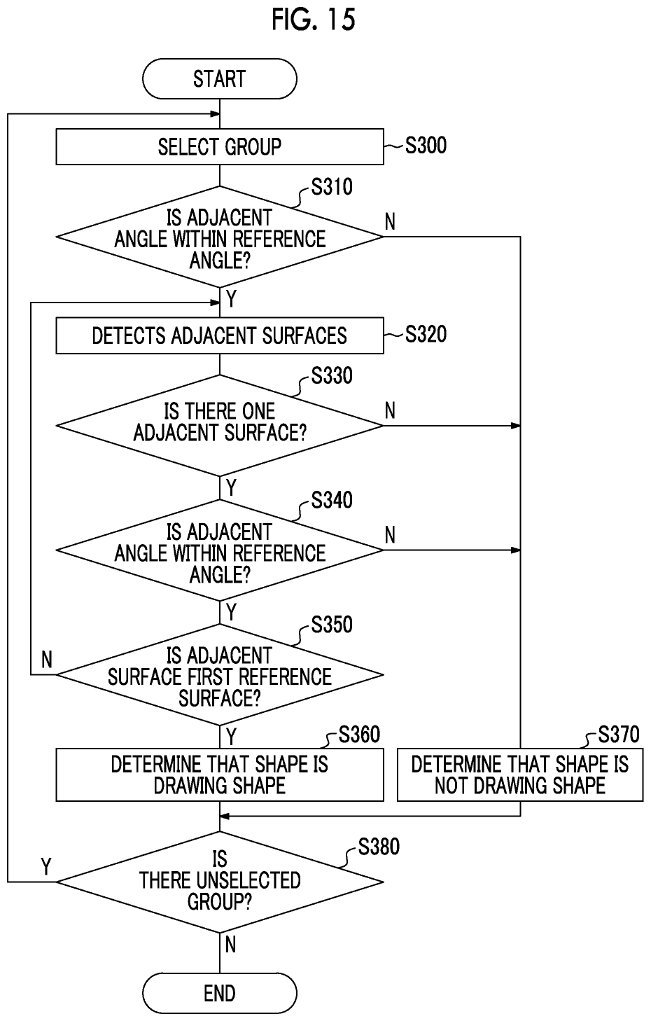

FIG. 15 is a flowchart showing an example of the flow of additional drawing determination processing that is executed by the CPU 11 of the information processing apparatus 1 in a case where there is an adjacent surface group 9 classified into the second group.

An information processing program defining the additional drawing determination processing is stored in, for example, the ROM 12 of the information processing apparatus 1 in advance. The CPU 11 of the information processing apparatus 1 reads the information processing program stored in the ROM 12, and executes the additional drawing determination processing.

In Step S300, the CPU 11 selects any one adjacent surface group 9 among the adjacent surface groups 9 classified into the second group.

The CPU 11 determines in Step S310 whether or not an angle between the adjacent surface 3B forming the selected adjacent surface group 9 and the reference surface 3A is within the reference angle. An angle between surfaces, which are adjacent to each other, such as the reference surface 3A and the adjacent surface 3B and the adjacent surfaces 3B, is referred to as an “adjacent angle”. In a case where the adjacent angle is within the reference angle, the processing proceeds to Step S320.

Since the CPU 11 follows the other adjacent surfaces 3B adjacent to the adjacent surface 3B, the CPU 11 detects all the other adjacent surfaces 3B adjacent to the adjacent surface 3B in the Step S320. In this case, the CPU 11 is adapted not to detect adjacent surfaces 3B that have been detected once.

The adjacent surfaces 3B detected in Step S320 are referred to as “detected adjacent surfaces 3B”, and the adjacent surface 3B, which is used as a reference for the detection of the detected adjacent surfaces 3B, is referred to as a “reference adjacent surface 3B”.

The CPU 11 determines in Step S330 whether or not there is one detected adjacent surface 3B. In a case where there is one detected adjacent surface 3B, the processing proceeds to Step S340.

The CPU 11 determines in Step S340 whether or not an adjacent angle between the reference adjacent surface 3B and the detected adjacent surface 3B is within the reference angle. In a case where the adjacent angle is within the reference angle, the processing proceeds to Step S350.

Since there is one detected adjacent surface 3B and the adjacent angle is within the reference angle, the CPU 11 determines in Step S350 whether or not the detected adjacent surface 3B is the reference surface 3A in order to confirm whether or not a surface returns to the reference surface 3A in a case where the surface follows the adjacent surface 3B.

In a case where the detected adjacent surface 3B is not the reference surface 3A, the processing proceeds to Step S320 and the CPU 11 repeatedly executes processing of sequentially detecting new detected adjacent surfaces 3B using the current detected adjacent surface 3B as the reference adjacent surface 3B.

Moreover, in a case where it is determined in the determination processing of Step S350 that the detected adjacent surface 3B is the reference surface 3A, shapes detected while following from the adjacent surfaces 3B forming the adjacent surface groups 9 classified into the second group have the characteristics of a drawing shape having an escape. Accordingly, the processing proceeds to Step S360 and the CPU 11 determines in Step S360 that shapes represented by detected adjacent surface groups 9 are a drawing shape having an escape.

In the case of an example of the shape of the product 3 shown in FIG. 14, the adjacent surfaces 3B are detected, for example, in the order of the adjacent surface 3B-5, an adjacent surface 3B-51, an adjacent surface 3B-52, an adjacent surface 3B-53, an adjacent surface 3B-54, an adjacent surface 3B-55, and the adjacent surface 3B-6 and the adjacent surface 3B-5 and the adjacent surface 3B-6 are adjacent to the same reference surface 3A. Accordingly, it is determined that the shape of the product 3 shown in FIG. 14 is a drawing shape having an escape.

On the other hand, in a case where it is determined in the determination processing of Step S310 that an adjacent angle between the reference surface 3A and the adjacent surface 3B forming the adjacent surface group 9 is not within the reference angle, in a case where it is determined in the determination processing of Step S330 that there is no detected adjacent surface 3B or there are a plurality of detected adjacent surfaces 3B, or in a case where it is determined in the determination processing of Step S340 that an adjacent angle between the reference adjacent surface 3B and the detected adjacent surface 3B is not within the reference angle, the processing proceeds to Step S370.

In this case, shapes detected while following from the adjacent surfaces 3B forming the adjacent surface groups 9 classified into the second group do not have the characteristics of a drawing shape having an escape. Accordingly, the CPU 11 determines in Step S370 that each of shapes represented by the adjacent surface groups 9 is not a drawing shape having an escape.

The CPU 11 determines in Step S380 whether or not there is an unselected adjacent surface group 9 not selected up to Step S300 among the adjacent surface groups 9 classified into the second group.

In a case where there is an unselected adjacent surface group 9, the processing proceeds to Step S300 and the CPU 11 selects the unselected adjacent surface group 9 from the adjacent surface groups 9 classified into the second group and repeatedly executes the processing of Steps S300 to S380 until it is determined in the determination processing of Step S380 that there is no unselected adjacent surface group 9. Accordingly, it is determined whether or not each of the shapes represented by the adjacent surface groups 9 classified into the second group is a drawing shape having an escape.

In a case where it is determined in the determination processing of Step S380 that there is no unselected adjacent surface group 9, the additional drawing determination processing shown in FIG. 15 ends.

In the case of a certain product 3, a reference surface 3A is separated into two surfaces by working, such as cutting, and the respective separated surfaces (referred to as “separated reference surfaces”) are connected to each other in a drawing shape having an escape shown in FIG. 14. In this case, the CPU 11 may determine in the determination processing of Step S350 of FIG. 15 whether or not the detected adjacent surface 3B is the other separated reference surface. Further, in a case where the CPU 11 detects the adjacent surfaces 3B in Step S320 and the adjacent surface 3B formed of a flat surface and the adjacent surface 3B formed of a fillet are alternately detected, the CPU 11 determines that the product has a drawing shape having an escape and based on the separated reference surfaces.

The CPU 11 detects the presence or absence of a drawing shape from the three-dimensional shape data of the product 3 in this way. In a case where there is a drawing shape in the product 3, the CPU 11 extracts similar process patterns from all the process patterns obtained from the combinations of the design elements that include the design elements related to drawing among the design elements of the 25 items affecting the number of press processes.

An aspect of the information processing apparatus 1 has been described above using the exemplary embodiment, but the disclosed embodiment of the information processing apparatus 1 is merely an example and the embodiment of the information processing apparatus 1 is not limited to a range described in the exemplary embodiment. Various changes or improvements can be applied to the exemplary embodiment without departing from the scope of the present disclosure, and embodiments to which the changes or improvements are applied are also included in the technical scope of the disclosure. For example, the order of the estimation processing shown in FIG. 2, the order of the drawing determination processing shown I FIG. 8, and the order of the additional drawing determination processing shown in FIG. 15 may be changed without departing from the scope of the present disclosure.

Further, the embodiment in which each above-mentioned processing is realized by software has been described in the exemplary embodiment by way of example. However, processing equivalent to the processing of the flowcharts of FIGS. 2, 8, and 15 may be processed by hardware. In this case, the processing is quickly executed as compared to as case where each processing is realized by software.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

An example in which the information processing program is stored in the ROM 12 has been described in the above-mentioned exemplary embodiment, but a part in which the information processing program is stored is not limited to the ROM 12. The information processing program according to an embodiment of the present disclosure can also be provided in a form in which the information processing program is recorded on a storage medium readable by the computer 10. For example, the information processing program may be provided in a form in which the information processing program is recorded on an optical disc, such as a compact disk read only memory (CD-ROM) and a digital versatile disk read only memory (DVD-ROM). Further, the information processing program may be provided in a form in which the information processing program is recorded in a field-portable semiconductor memory. Each of the ROM 12, the non-volatile memory 14, the CD-ROM, the DVD-ROM, the USB, and the memory card is an example of a non-transitory storage medium.

Furthermore, the information processing apparatus 1 may download the information processing program from an external device connected to a communication line and may store the downloaded information processing program in the memory. In this case, the CPU 11 of the information processing apparatus 1 reads the information processing program, which is downloaded from the external device, and executes each processing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
specify a design element of a product, which affects cost of the product, from three-dimensional shape data of the product and a production requirement for the product; and
output a cost reduction measure for the product related to the design element of the product and an amount of reduced cost of the product that is obtained in a case where the cost reduction measure for the product is executed.

2. The information processing apparatus according to claim 1, wherein the processor is configured to:
output a proposed change related to a design element of the product, which reduces cost generated depending on the production requirement for the product, as the cost reduction measure for the product.

3. The information processing apparatus according to claim 2, wherein the processor is configured to:
output information about a change in the production requirement for the product, which is obtained in a case where the proposed change related to the design element of the product is performed, together with the amount of reduced cost of the product.

4. The information processing apparatus according to claim 2, wherein the processor is configured to:
output the three-dimensional shape data of the product, which represents a position of the design element of the product proposed to be changed by the cost reduction measure for the product, together with the cost reduction measure for the product.

5. The information processing apparatus according to claim 3, wherein the processor is configured to:
output the three-dimensional shape data of the product, which represents a position of the design element of the product proposed to be changed by the cost reduction measure for the product, together with the cost reduction measure for the product.

6. The information processing apparatus according to claim 1, wherein the processor is configured to:
specify a design element, which is recommended to be changed in the cost reduction measure for the product, from a plurality of design elements that are associated with a cost requirement predetermined as an item affecting the cost of the product for each production requirement.

7. The information processing apparatus according to claim 2, wherein the processor is configured to:
specify a design element, which is recommended to be changed in the cost reduction measure for the product, from a plurality of design elements that are associated with a cost requirement predetermined as an item affecting the cost of the product for each production requirement.

8. The information processing apparatus according to claim 3, wherein the processor is configured to:
specify a design element, which is recommended to be changed in the cost reduction measure for the product, from a plurality of design elements that are associated with a cost requirement predetermined as an item affecting the cost of the product for each production requirement.

9. The information processing apparatus according to claim 4, wherein the processor is configured to:
specify a design element, which is recommended to be changed in the cost reduction measure for the product, from a plurality of design elements that are associated with a cost requirement predetermined as an item affecting the cost of the product for each production requirement.

10. The information processing apparatus according to claim 5, wherein the processor is configured to:
specify a design element, which is recommended to be changed in the cost reduction measure for the product, from a plurality of design elements that are associated with a cost requirement predetermined as an item affecting the cost of the product for each production requirement.

11. The information processing apparatus according to claim 6,
wherein the cost requirement is molding machine tonnage of an injection molding machine in a case where the product is manufactured by the injection molding machine, and
the processor is configured to: estimate a limiting element, which limits the molding machine tonnage of the injection molding machine, from elements of a mold clamping force, a mold size, and an extraction stroke that affect the molding machine tonnage of the injection molding machine; and use a design element, which affects the limiting element, as the design element that is recommended to be changed in the cost reduction measure for the product.

12. The information processing apparatus according to claim 7,
wherein the cost requirement is molding machine tonnage of an injection molding machine in a case where the product is manufactured by the injection molding machine, and
the processor is configured to: estimate a limiting element, which limits the molding machine tonnage of the injection molding machine, from elements of a mold clamping force, a mold size, and an extraction stroke that affect the molding machine tonnage of the injection molding machine; and use a design element, which affects the limiting element, as the design element that is recommended to be changed in the cost reduction measure for the product.

13. The information processing apparatus according to claim 8,
wherein the cost requirement is molding machine tonnage of an injection molding machine in a case where the product is manufactured by the injection molding machine, and
the processor is configured to: estimate a limiting element, which limits the molding machine tonnage of the injection molding machine, from elements of a mold clamping force, a mold size, and an extraction stroke that affect the molding machine tonnage of the injection molding machine; and use a design element, which affects the limiting element, as the design element that is recommended to be changed in the cost reduction measure for the product.

14. The information processing apparatus according to claim 9,
wherein the cost requirement is molding machine tonnage of an injection molding machine in a case where the product is manufactured by the injection molding machine, and
the processor is configured to: estimate a limiting element, which limits the molding machine tonnage of the injection molding machine, from elements of a mold clamping force, a mold size, and an extraction stroke that affect the molding machine tonnage of the injection molding machine; and use a design element, which affects the limiting element, as the design element that is recommended to be changed in the cost reduction measure for the product.

15. The information processing apparatus according to claim 10,
wherein the cost requirement is molding machine tonnage of an injection molding machine in a case where the product is manufactured by the injection molding machine, and
the processor is configured to: estimate a limiting element, which limits the molding machine tonnage of the injection molding machine, from elements of a mold clamping force, a mold size, and an extraction stroke that affect the molding machine tonnage of the injection molding machine; and use a design element, which affects the limiting element, as the design element that is recommended to be changed in the cost reduction measure for the product.

16. The information processing apparatus according to claim 6,
wherein the cost requirement is the number of processes of press working required to manufacture the product in a case where the product is manufactured by a press, and
the processor is configured to: extract a process pattern, in which the number of processes is smaller than the number of current processes of the press working required to manufacture the product, from all process patterns that are obtained from combinations of a plurality of predetermined design elements determining the number of processes of the press working; and use a design element, which contributes to a reduction in the number of processes so that the product is manufactured according to the extracted process pattern, as the design element that is recommended to be changed in the cost reduction measure for the product.

17. The information processing apparatus according to claim 16, wherein the processor is configured to:
detect presence or absence of a drawing shape, which requires drawing, using three-dimensional shape data of the product; and
extract a process pattern, in which the number of processes is smaller than the number of current processes of the press working required to manufacture the product, from all process patterns that are obtained from combinations of design elements including a design element related to drawing in a case where there is a drawing shape in the product.

18. The information processing apparatus according to claim 17, wherein the processor is configured to:
group adjacent surfaces that are adjacent to a reference surface of the product so as to form angles with respect to the reference surface;
repeatedly group the adjacent surfaces, which use the grouped adjacent surfaces as a new reference surface, until it is confirmed that an inside of a closed path is a closed region in a case where the closed path is formed by the grouped adjacent surfaces; and
output that there is a drawing shape in the product in a case where a closed region is formed by a group of the adjacent surfaces.

19. The information processing apparatus according to claim 17, wherein the processor is configured to:
repeatedly detect a new adjacent surface adjacent to an adjacent surface in a case where the number of adjacent surfaces adjacent to a reference surface so as to form angles with respect to the reference surface is one; and
output that there is a drawing shape in the product in a case where an angle between the adjacent surface and a surface adjacent to the adjacent surface is within a predetermined reference angle and the detected adjacent surface is a reference surface of the product.

20. A non-transitory computer readable medium storing an information processing program causing a computer to execute a process comprising:
specifying a design element of a product, which affects cost of the product, from three-dimensional shape data of the product and a production requirement for the product; and
outputting a cost reduction measure for the product related to the design element of the product and an amount of reduced cost of the product that is obtained in a case where the cost reduction measure for the product is executed.
